(19) United States
(12) Patent Application Publication
(10) Pub. No.: US 2010/0036652 A1
(43) Pub. Date: Feb. 11, 2010

(54) SYSTEM AND METHOD FOR PROVIDING HEALTH ENHANCEMENT SERVICES

(75) Inventor: Jaebong Kim, Gyeonggi-do (KR)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/189,561

(22) Filed: Aug. 11, 2008

(30) Foreign Application Priority Data
Aug. 5, 2008 (KR) 10-2008-76352

(51) Int. Cl. G06G 7/48

(52) U.S. Cl. 703/11

(57) ABSTRACT

Methods and apparatus are described for providing health enhancement services through which geographical information such as an exercise route on a map can be obtained. According to various embodiments, heath enhancement services are provided that can effectively share exercise-related information among various people.

### BACKGROUND OF THE INVENTION

The present invention generally relates to systems and methods for exercise management, and more particularly to a system and method for showing various exercise data in a graphical manner.

Nowadays, people are more enthusiastic about their health. Thus, the number of people exercising has increased. Accordingly, various exercise-related systems have been introduced in the market. The exercise-related systems function to encourage people to exercise and provide people with useful information on their performance.

However, existing exercise-related systems are limited in terms of their operation. For example, existing exercise-related systems cannot adequately share information among various people. If the information regarding exercise can be shared in a more effective way, then people may find exercising more enjoyable and thus become more motivated to exercise through competition.

Further, information provided by existing exercise-related systems is limited to basic information such as speed, distance, caloric information, etc. Further, geographical information such as actual routes taken by others on a map is not provided by existing exercise-related systems. If an exerciser can check exercise routes taken by others on a map, then he/she can compare the exercise routes with his/her own route and may become motivated to create a new exercise route.

In addition, providing route information on a map allows an exerciser who is not familiar with the area to determine a route around such area so as to facilitate his/her exercise. Taking a new route which is different from a previous one may provide more enjoyment when exercising.

### SUMMARY OF THE INVENTION

According to various embodiments of the present invention, systems and methods are described for providing health enhancement services through which geographical information such as an exercise route on a map can be obtained. According to various embodiments, heath enhancement services are provided that can effectively share exercise-related information among various people.

In accordance with one embodiment of the present invention, there is provided a system for providing health enhancement services through a communication network. The system comprises a controller, a route calculation module, and a database. The controller may be configured to receive exercise records from users through the communication network. In one embodiment, each of the exercise records includes data on an exercise route taken by the respective user. The route calculation module may be configured to calculate coordinates of the exercise routes, displayable on the map, based on the exercise records. The database may be configured to store the calculated coordinates. The controller may be further configured to retrieve the calculated coordinates and provide a web page with the calculated coordinates indicated on the map.

In accordance with another embodiment of the present invention, a method of providing health enhancement services through a communication network is provided. According to such method, an exercise record is received from a user through the communication network. In such a case, the exercise record includes data on an exercise route taken by the user. Based on the exercise record, coordinates of the exercise route are calculated and stored. For a plurality of different users, the steps of receiving an exercise record, calculating coordinates of an exercise route and storing the calculated coordinates are repeated. Then, a user request for a service web page is received from a particular user through the communication network. In response to receiving the user request, the calculated coordinates are retrieved. Then, the service web page with the calculated coordinates indicated on the map is provided to the particular user through the communication network.

In accordance with further embodiments of the invention, a first interface is presented to a user by which the user may enter an exercise record. The exercise record includes data relating to a first exercise route taken by the user. A second interface is presented to the user including coordinates indicated on a map. The coordinates corresponding to the first exercise route and at least one additional exercise route taken by a different user.

A further understanding of the nature and advantages of the present invention may be realized by reference to the remaining portions of the specification and the drawings.

### BRIEF DESCRIPTION OF THE DRAWINGS

FIG. 1 shows a network configuration including a health enhancement system in accordance with one embodiment of the present invention.

FIG. 2 provides a flow chart illustrating a process of providing health enhancement services according to one embodiment of the present invention.

FIG. 3 shows a flow chart illustrating a process of providing web pages between a client computer and a health enhancement server according to one embodiment of the present invention.

FIG. 4 shows one example of a web page provided in accordance with one embodiment of the present invention.

FIG. 5 illustrates one example of a web page provided when a user clicks a particular user name in FIG. 4.

FIG. 6 shows one example of a web page provided when a user clicks a particular exercise date in FIG. 5.

FIG. 7 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

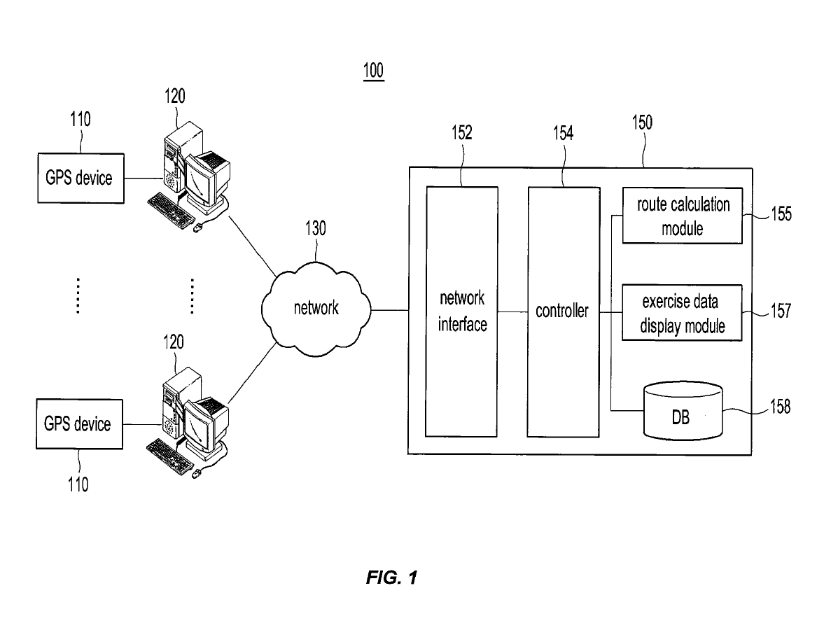

FIG. 1 shows a network configuration including a system for providing health enhancement services (“health enhancement system”) in accordance with one embodiment of the present invention. The system 100 may comprise a GPS device 110 for collecting NMEA data. The GPS device 110 may be portable and carried by a user during an exercise session. In one embodiment, the GPS device 110 may be a commercially available GPS receiver that operates according to the standard NMEA (National Marine Electronics Association) protocol. During the exercise session, the GPS device 110 may communicate with a satellite to collect NMEA data such as time, position, velocity, etc. For details of the NMEA data, various on-line sites may be referred to such as, for example,
http://home.pacific.net.au,
http://erine.egloos.com/2233135,
http://www.nmea.org,
http://www.gpsinformation.org/dale/nmea.htm,
http://home.pacific.net.au/˜gnb/gps/nmea.html, etc.
   In one embodiment, the product, GPS-CS1, manufactured by SONY Corporation may be used as the GPS device 110 for collecting the NMEA data based on the satellite signals.

With reference to FIG. 1, the GPS device 110 may be connected to a client computer 120. The client computer 120 may be operable for NMEA data to be uploaded from the GPS device 110. In one embodiment, for uploading NMEA data to the client computer 120, the GPS device 110 may be equipped with a USB plug for insertion into a USB port provided on the client computer 120. According to the type of the GPS device 110, various uploading processes may be performed. Although the GPS device 110 is illustrated as being connected to the client computer 120 for uploading, the uploading process may be carried out by a wireless network. The client computer 120 may be a laptop, notebook, desktop, or other types of computing device, as well as a personal digital assistant (PDA) device, a mobile, or cellular telephonic device, or the like. Embodiments are also contemplated in which the functions performed by the GPS device 110 and the client computer 120 are integrated in a single device.

The client computer 120 may be in communication via network 130 with a health enhancement server 150, which will be described in detail below. Data communicated from the client computer 120 to the health enhancement server 150 may include NMEA data, user requests to view web pages relating to health enhancement services, various data necessary for a log-in process, etc. Data communicated from the health enhancement server 150 to the client computer 120 may include web items, such as maps, graphs, text, etc., which are necessary for displaying web pages providing health enhancement services. In one embodiment, the client computer 120 may be programmed to transfer the data to the health enhancement server 150 in response to a receipt of NMEA data from the GPS device 110. Alternatively, the client computer 120 may be configured to transfer the data to the health enhancement server 10 upon receiving user requests. In one embodiment, the client computer 120 may include software for displaying the web items. Such software may be a general purpose browser application or any type of software modules that can be plugged into the general purpose browser application, which is executed by the Central Processing Unit (CPU) of the client computer 120 to cause the client computer 120 to display the web items. The client computer 120 may be further configured to perform data encryption for outgoing communications and data decryption for incoming communications. The network 130 may preferably be the Internet or other similar wide area network, which is provided by one or more telecommunications companies and allows the client computer 120 to access the health enhancement server 150 over a wide geographic area.

The health enhancement server 150 may include a network interface 152 designed to transfer communications between the client computer 120 and the health enhancement server 150 in a reciprocal way. The network interface 152 may be configured to perform interface functions to transfer user requests from the client computer 120 and process results in response thereto, which are originated from within the health enhancement server, to and from the health enhancement server 150 and the client computer 120. The network interface 152 may be configured to perform data encryption for outgoing communications and data decryption for incoming communications. The network interface 152 may be constructed to implement a suitable communication protocol between the client computer 120 and the health enhancement server 150. In a particular embodiment, the Representational State Transfer (REST) architectural style or Simple Object Access Protocol (SOAP) may be employed. Further, in various embodiments, the TCP or UDP protocol may be employed. The network interface 152 may be configured to perform a log-in process. Alternatively, a separate module (not shown) may be installed to perform a log-in process.

The controller 154 may supervise the overall operations of the health enhancement server 150. In one embodiment, in response to receiving the incoming data from the network interface 152, the controller 154 may decide which operation is needed. Depending on the decision result, the controller 154 may issue commands to one or more relevant modules including necessary data constituting at least part of the incoming data. The controller 154 may also be configured to retrieve suitable information from a database 158, organize web pages by using the retrieved information, and transfer the web pages to the client computer 120 through the network interface 152.

In one embodiment, the health enhancement server 150 may further include a route calculation module 155, an exercise data display module 157, and a database 158. In one embodiment, the database 158 may include personal information, such as height, weight, age, etc., for the users subscribed to the service. For example, such personal information may be obtained when a user logs in to a web page run by the health enhancement server 150 for the first time. In one class of embodiments of the present invention, the database 158 may be constructed by using an open/commercial RDBMS (Relational Database Management System). Although the database 158 is illustrated as being constructed inside the health enhancement server 150, one of ordinary skill in the art would appreciate that the database 138 can be separately installed outside of the health enhancement server 150 (which may also represent one or more computing devices).

The route calculation module 155 may function to calculate coordinates of an actual route taken by a user and store the process results including the calculated coordinates in the database 158. The calculated coordinates may be used to display the route which is taken by a user on a map. For the calculation, the route calculation module 155 may convert the GPS coordinates used in the NMEA data to the type capable of being displayed on a map such as, but not limited to, WGS 84 coordinates which is adapted for Yahoo! Maps. For details of the conversion from the GPS coordinates to WGS 84 coordinates, the site such as http://www.posc.org/Epicentre.2-2/DataModel/ExamplesofUsage/eu_cs35.html may be referred to. As one example, the following indicates example code through which the GPS coordinates are converted into the data capable of being displayed on a map.
locList[locList.length]=new YGeoPoint(37.360223333333,127.11023833333);
locList[locList.length]=new YGeoPoint(37.359733333333,127.10978);
locList[locList.length]=new YGeoPoint(37.358996666667,127.11013333333);
var poly1=new YPolyline(locList,‘blue’,4,0.5);
ymap.addOverlay(poly1);
var info=ymap.getBestZoomAndCenter(locList);
ymap.drawZoomAndCenter(info.YGeoPoint,info.zoomLevel);

The exercise data display module 157 may function to obtain various data related to the exercise session by using the NMEA data and personnel information. In one embodiment, various data provided by the exercise data display module 157 may include the number of exercise sessions a user performs, average velocity, total distance, exercise quantity, calories consumed during an exercise session, etc. The number of exercise sessions a user performs may be obtained, for example, based on the number of times that the health enhancement server 150 receives the NMEA data from the client computer 120. The calories consumed during an exercise session may be determined by multiplying the time spent during an exercise session and the calories consumed by the type of exercise for an hour. For calculating the calories consumed during an exercise session, the exercise data display module 157 may store information on the calories consumed by various types of exercise for an hour in advance. As one example, such information on the calories consumed by various types of exercise for an hour is available on the on-line sites such as http://www.ezday.co.kr/miz/diet/calorie/info_out.html?q_left_menu=miz_health. Further, the calories consumed during a type of exercise for an hour may depend on the personal information such as the weight of a user. Thus, for the calculation, the exercise data display module 157 may be programmed to access the database 158 to retrieve the personal information. In the similar manner, one of ordinary skill in the art may easily calculate the average velocity, total distance, exercise quantity, etc., by using a suitable algorithm known in the art. Thus, detailed explanations thereof will be omitted herein. The exercise data display module 157 may store the process results including various exercise data, such as the number of exercise sessions a user performs, average velocity, total distance, exercise quantity, calories consumed during an exercise session, etc., in the database 158. While the health enhancement server 150 shown in FIG. 1 is illustrated as including a route calculation module 155, an exercise data display module 157, and a database 158, it should be noted that various other embodiments are possible.

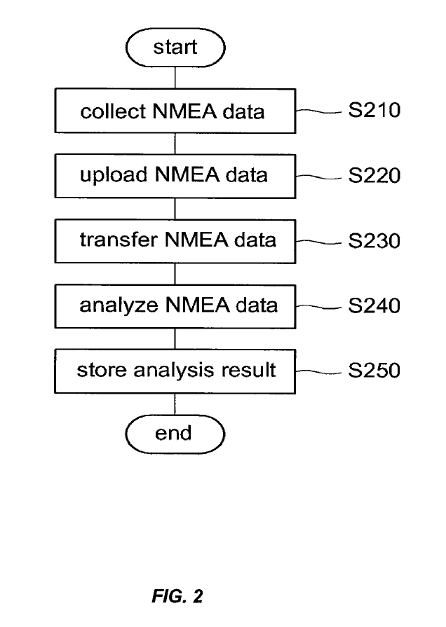

The specific procedures according to one embodiment of the health enhancement services are explained below in detail. FIG. 2 provides a flow chart illustrating a process to provide health enhancement services according to one embodiment of the present invention.

At step 210 of FIG. 2, the NMEA data is collected during an exercise session by using a GPS device 110. The collected NMEA data is uploaded to the client computer 120 at step 220. In one embodiment, for uploading the NMEA data, if a USB plug is available on the GPS device 110, then a user may insert the USB plug into a USB port provided on the client computer 120. After being uploaded to the client computer 120, the NMEA data is transferred to the health enhancement server 150 the step 230. For such transfer, a user may connect to a web page providing the health enhancement services, log into the web page and click the uploading button provided on the web page. In response to the user's click, a suitable process through which the NMEA data is transferred from the client computer 120 to the health enhancement server 150 will be performed. According to various embodiments, the transfer process may be performed automatically after the uploading process.

Once, the NMEA data is transferred from the client computer 120, the health enhancement server 150 analyzes the NMEA data at step 240. According to various embodiments, an analysis of the NMEA data may be performed automatically after the transfer process 230 or be performed in response to a corresponding user request. Such user request may be received through a web page. In one embodiment, in response to receiving NMEA data from the client computer 120, the controller 154 may issue a command to the route calculation module 155 to calculate the coordinates of an actual route taken by a user. The controller 154 may also issue a command to the exercise data display module 157 to obtain various data related to the exercise session by using the NMEA data and personal information. After the analysis, the route calculation module 155 and the exercise data display module 157 store the analysis results at step 250. In one embodiment, the analysis results may include the converted coordinates that can be displayed on a map and various exercise data such as the exercise type, the number of exercise sessions a user performs, average velocity, total distance, exercise quantity, calories consumed during an exercise, etc.

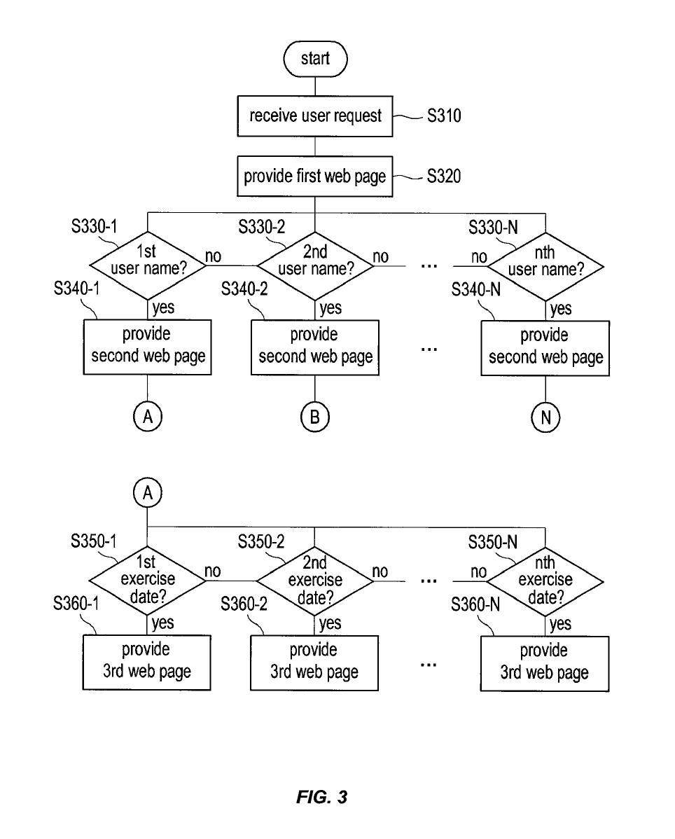

FIG. 3 shows a flow chart illustrating a process of providing web pages between a client computer and a health enhancement server according to one embodiment of the present invention.

As illustrated in FIG. 3, the process begins by receiving a user request to view the web pages providing health enhancement services at step 310. In response to receiving the user request, the controller 154 retrieves information relevant to the user request and organizes a first web page based on the retrieved information. Then, the controller 154 transfers the first web page to the client computer 120 through the network interface 152 at step 320. In one embodiment, the health enhancement server 150 may provide the web pages for a log-in process to the client computer 120 prior to transferring the first web page.

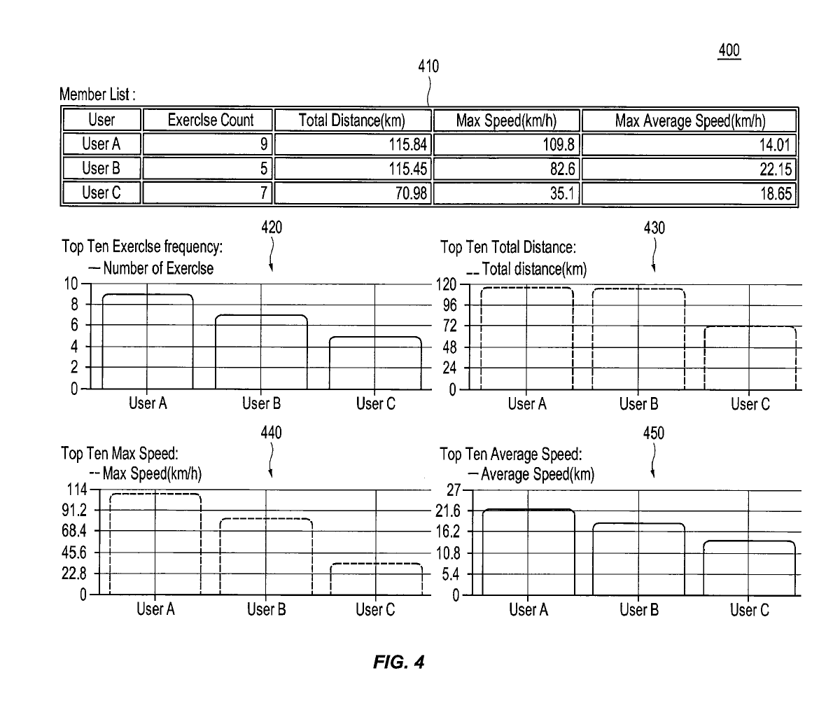

FIG. 4 shows one example of a web page which may be provided at step 320. As shown in FIG. 4, the web page 400 shows a table 410 on the upper part of the web page 400 and various graphs 420, 430, 440, and 450 on the bottom part of the web page 400. As shown in FIG. 4, various graphs 420, 430, 440, and 450 show exercise frequency, total distance, max speed and average speed, respectively. For example, the graph 420 shows exercise frequency of “User A,” “User B” and “User C,” and thus, a user can recognize his/her state, i.e., how frequently he/she exercises, compare his/her data to others, and modify his/her exercise plan accordingly.

As shown in FIG. 4, the table 410 includes user names, i.e., “User A,” “User B” and “User C,” as well as the exercise data corresponding to the users. In one embodiment, the table 410 may indicate all the users subscribing to the health enhancement services. Alternatively, the table 410 may indicate the users who take exercise in the same region as the user who logged in. In such a case, the health enhancement server 150 may classify the users into a plurality of regional groups based on location information obtained from the NMEA data the user sent. For such classification, reverse geocoding technology, which is already known in the art, may be used to determine the region that each user falls within. If the table 410 includes only the users who fall within the same region, then the exercise information such as an exercise route may be more effectively exchanged. One of ordinary skill in the art would appreciate that the items included in the table 410 and the types of graphs 420, 430, 440, and 450 for showing the exercise data may be differently embodied according to various embodiments of the present invention. In one embodiment, each of the user names included in the table 410 may be linked to another page. That is, the user who is provided with the first web page 400 may click one of the user names included in the table 410. In such a case, the health enhancement server 150 determines which user name is selected by the user at step 330. In response to receiving a click of a particular user name by the user, the health enhancement server 150 retrieves information relevant to the user request and organizes a second web page based on the retrieved information. Then, the health enhancement server 150 transfers the second web page to the client computer 120 at step 340.

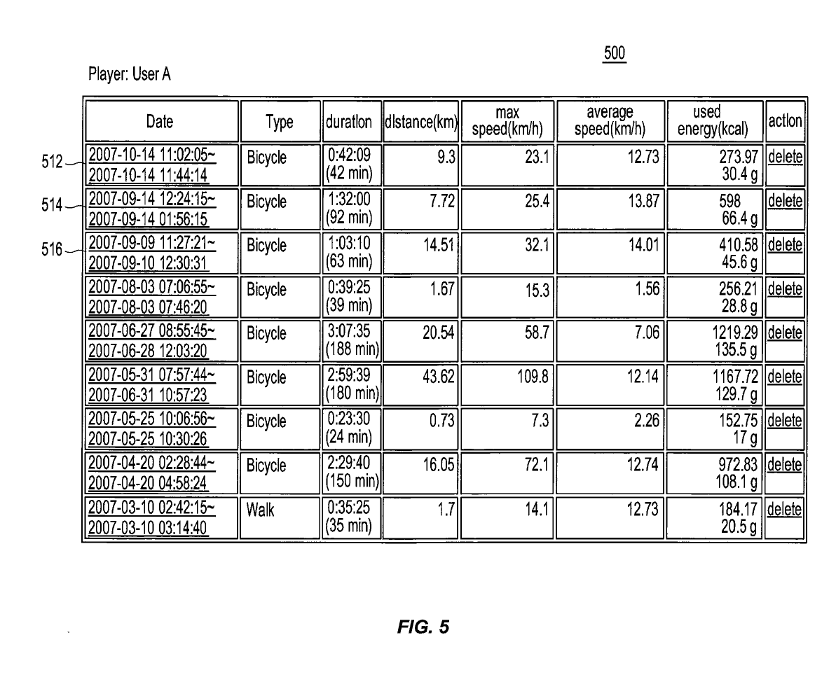

FIG. 5 illustrates an example of a web page which may be provided when a user clicks a particular user name in accordance with the one embodiment. As shown in FIG. 5, the web page 500 includes exercise data for a particular user, “User A,” among many users. With reference to FIG. 5, in one embodiment, the exercise data includes the exercise date, types of exercises, duration, distance, max speed, average speed, and consumed calories. The types of exercises may be obtained through a user's input of the type of exercise when uploading the NMEA data to the health enhancement server 150. In one embodiment, the exercise date may be linked to another page. That is, the user viewing the second web page 500 may click a particular exercise date among many exercise dates 512, 514, and 516. In response to receiving the click by the user, the health enhancement server 150 determines which exercise date is selected by the user at step 350 and transfers a third web page corresponding to the selected exercise date to the client computer 120 at step 360. Although only flow chart A, which includes the steps 350-1 to 350-N and 360-1 and 360-N, is illustrated in FIG. 3, it should be noted herein that one of ordinary skill in the art would easily recognize that flow charts B to N may include steps similar to those of flow chart A.

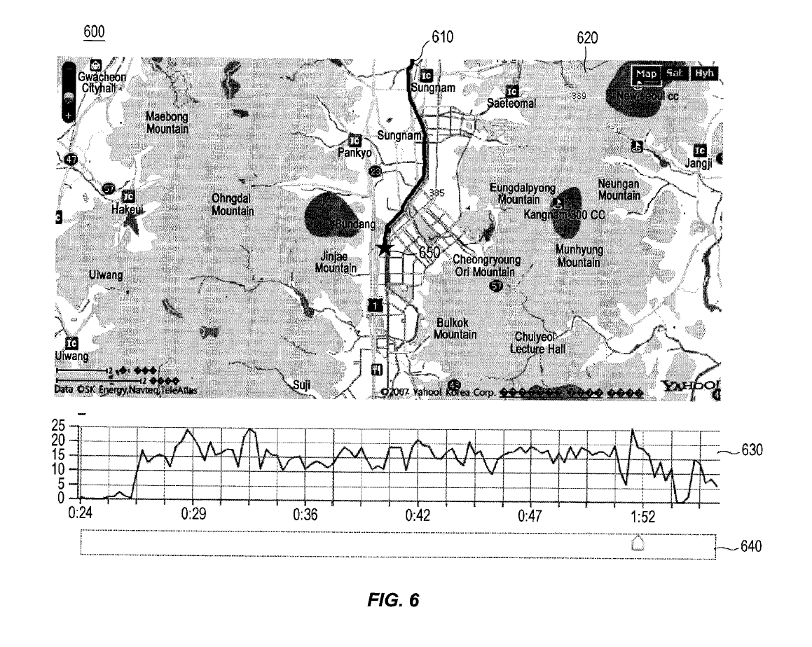

FIG. 6 shows an example of a web page 600 which may be provided when a user clicks a particular exercise date. The web page 600 shows an exercise route 610 on a map 620, which is performed during the selected exercise time. The web page 600 may be further embodied to show a graph 630 illustrating the velocity and exercise quantity. In one embodiment, if a user points out a specific time at a time bar 640, then the location of the user at the specific time may be indicated with a marker. In FIG. 6, the star mark 650 is used as the marker to indicate the location of the user at the specific time. As such, the user can check exercise routes taken by others and compare the exercise routes with his/her exercise route. After the comparison, a user can challenge a new route generated by referring to the exercise routes of others, and thus, the interest for exercise may be increased. Further, due to a visual display of the exercise route on the map, a user can easily understand the route.

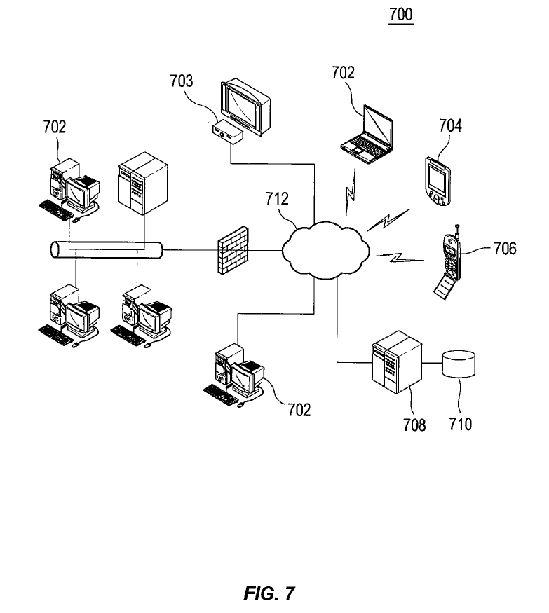

Embodiments of the present invention may be employed to provide health enhancement services in any of a wide variety of computing contexts. For example, as illustrated in FIG. 7, implementations are contemplated in which the relevant population of users interacts with a diverse network environment via any type of computer (e.g., desktop, laptop, tablet, etc.) 702, media computing platforms 703 (e.g., cable and satellite set top boxes and digital video recorders), handheld computing devices (e.g., PDAs, email clients, etc.) 704, cell phones 706 or any other type of computing or communication platform.

As will be understood, the various processes and services enabled by embodiments of the present invention may be provided in a centralized manner. This is represented in FIG. 7 by a server 708 and a data store 710 which, as will be understood, may correspond to multiple distributed devices and data stores. The health enhancement services may then be provided to users in the network via the various channels with which the users interact with the network.

The various aspects of the present invention may also be practiced in a wide variety of network environments (represented by network 712) including, for example, TCP/IP-based networks, telecommunications networks, wireless networks, etc. In addition, the computer program instructions and data structures with which embodiments of the present invention are implemented may be stored in any type of tangible computer-readable media, and may be executed according to a variety of computing models including, for example, a client/server model, a peer-to-peer model, on a stand-alone computing device, or according to a distributed computing model in which various functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A system for providing health enhancement services through a communication network, comprising:
a controller for receiving exercise records from users through the communication network, each of the exercise records including data on an exercise route taken by the respective user;
a route calculation module for calculating coordinates of the exercise routes based on the exercise records, said coordinates being displayable on a map; and
a database for storing the calculated coordinates,
wherein said controller is configured to retrieve the calculated coordinates and provide a web page with the calculated coordinates indicated on the map in response to user requests.

2. The system of claim 1, wherein the database is further configured to store personal information of the users, and wherein said system further comprises an exercise data display module configured to obtain exercise-related data of the users based on the respective exercise records and personal information.

3. The system of claim 2, wherein the exercise-related data of the users are stored in the database.

4. The system of claim 2, wherein the personal information includes a height, a weight, and an age of the users.

5. The system of claim 2, wherein the exercise-related data includes one or more of a number of exercise sessions a user performs, an average velocity, a total distance, an exercise quantity, or calories consumed during a particular exercise session.

6. The system of claim 5, wherein the number of exercise sessions the user performs is obtained based on a number of exercise records received from the user.

7. The system of claim 1, wherein each of the exercise records includes NMEA data.

8. The system of claim 1, wherein the calculated coordinates are WGS 84 coordinates.

9. A computer-implemented method of providing health enhancement services through a communication network, comprising:
(a) receiving an exercise record from a user through the communication network, said exercise record including data on an exercise route taken by the user;
(b) calculating coordinates of the exercise route based on the exercise record, said coordinates being displayable on a map;
(c) storing the calculated coordinates;
(d) repeating steps (a) to (c) for a plurality of different users;
(e) receiving a user request for a service web page from a particular user through the communication network;
(f) retrieving the calculated coordinates in response to receiving the user request; and
(g) providing the service web page with the calculated coordinates indicated on the map to the particular user through the communication network.

10. The method of claim 9, further comprising:
(b1) obtaining exercise-related data of the user;
(c1) storing the exercise-related data; and
(d1) repeating steps (b1) and (c1) for a plurality of different users.

11. The method of claim 10, further comprising storing personal information of the plurality of different users.

12. The method of claim 11, wherein obtaining exercise-related data of the user includes obtaining exercise-related data of the user based on the respective exercise records and personal information.

13. The method of claim 11, wherein the personal information includes a height, a weight, and an age of the plurality of different users.

14. The method of claim 10, wherein the exercise-related data includes one or more of a number of exercise sessions a user performs, an average velocity, a total distance, an exercise quantity, or calories consumed during a particular exercise session.

15. The method of claim 14, wherein the number of exercise sessions a user performs is obtained based on a number of exercise records received from the user.

16. The method of claim 9, wherein each of the exercise records includes NMEA data.

17. The method of claim 9, wherein the calculated coordinates are WGS 84 coordinates.

18. A computer-implemented method of providing health enhancement services, comprising:
(a) presenting a first interface to a user by which the user may enter an exercise record, said exercise record including data relating to a first exercise route taken by the user; and
(b) presenting a second interface to the user, the second interface including coordinates indicated on a map, the coordinates corresponding to the first exercise route and at least one additional exercise route taken by a different user.
